(19) United States
(12) Patent Application Publication
(10) Pub. No.: US 2012/0049005 A1
(43) Pub. Date: Mar. 1, 2012

(54) MECHANICALLY OPENING PARACHUTE

(76) Inventor: BONG H. SUH, Rockville, MD (US)

(21) Appl. No.: 13/288,652

(22) Filed: Nov. 3, 2011

Related U.S. Application Data
(63) Continuation-in-part of application No. PCT/US2009/005485, filed on Oct. 6, 2009.
Application No. PCT/US2009/005485 is a continuation-in-part of application No. 13/035,593, filed on Feb. 25, 2011.
(60) Provisional application No. 61/282,640, filed on Mar. 10, 2010.

(51) Int. Cl. B64D 17/02; B64D 17/62; B64D 17/30

(52) U.S. Cl. 244/145

(57) ABSTRACT

The mechanically opening parachute is a parachute that may be opened quickly at low altitudes, such as during an emergency exit from an office building, for example. The mechanically opening parachute includes a telescopic tube having opposed upper and lower ends. A harness adapted for releasably holding the user is secured to the lower end of the telescopic tube. The mechanically opening parachute operates similarly to a conventional umbrella, with the telescopic tube automatically opening upon actuation by the user, and with a conventional umbrella stretcher opening a plurality of ribs secured to a parachute canopy. Preferably, an annular skirt is fixed about the perimeter of the canopy. Suspension cords extend from the annular skirt to the lower end of the telescopic tube.

### CROSS-REFERENCE TO RELATED APPLICATIONS

This application is a continuation-in-part of PCT Patent Application Serial No. PCT/US2009/005485, filed Oct. 6, 2009, and of U.S. patent application Ser. No. 13/035,593, filed Feb. 25, 2011, which claimed the benefit of U.S. Provisional Patent Application Ser. No. 61/282,640, filed Mar. 10, 2010.

### BACKGROUND OF THE INVENTION

1. Field of the Invention

The present invention relates to parachutes and, particularly, to a mechanically opening parachute that may be used quickly in emergency situations.

2. Description of the Related Art

A parachute is a device used to slow the motion of an object through an atmosphere by creating drag. A parachute is made from thin, lightweight fabric, support tapes and suspension lines. The lines are usually gathered through cloth loops or metal connector links at the ends of several strong straps called risers. The risers in turn are attached to the harness containing the load. As the thin material inflates it increases drag and in turn slowing down the object it is carrying. The parachute successfully slows down the object enough so that it does not break on impact with the ground.

Reserve parachutes usually have a ripcord deployment system, but most modern main parachutes used by sports parachutists use a form of hand-deployed pilot chute. A ripcord system pulls a closing pin (sometimes multiple pins), which releases a spring-loaded pilot chute, and opens the container; the pilot chute is then propelled into the air stream by its spring, then uses the force generated by passing air to extract a deployment bag containing the parachute canopy, to which it is attached via a bridle. A hand-deployed pilot chute, once thrown into the air stream, pulls a closing pin on the pilot chute bridle to open the container, then the same force extracts the deployment bag.

Only the hand-deployed pilot chute may be collapsed automatically after deployment (by a kill line reducing the in-flight drag of the pilot chute on the main canopy). Reserves, on the other hand, do not retain their pilot chutes after deployment. The reserve deployment bag and pilot chute are not connected to the canopy in a reserve system. This is known as a free-bag configuration, and the components are often lost during a reserve deployment.

Occasionally, a pilot chute does not generate enough force either to pull the pin or to extract the bag. Causes may be that the pilot chute is caught in the turbulent wake of the jumper (the “burble”), the closing loop holding the pin is too tight, or the pilot chute is generating insufficient force. This effect is known as “pilot chute hesitation,” and, if it does not clear, it can lead to a total malfunction, requiring reserve deployment.

Paratroopers' main parachutes are usually deployed by static lines that release the parachute, yet retain the deployment bag that contains the parachute, without relying on a pilot chute for deployment. In this configuration, the deployment bag is known as a direct-bag system, in which the deployment is rapid, consistent, and reliable. This kind of deployment is also used by student skydivers going through a static line progression, a type of student program.

A parachute is carefully folded, or “packed” to ensure that it will open reliably. If a parachute is not packed properly it can result in death because the main parachute might fail to deploy correctly or fully. In the United States and many other developed countries, emergency and reserve parachutes are packed by “riggers”, who must be trained and certified according to legal standards. Sport skydivers are always trained to pack their own primary “main” parachutes.

Parachutes can malfunction in several ways. Malfunctions can range from minor problems that can be corrected in-flight and still be landed, to catastrophic malfunctions that require the main parachute to be cut away using a modern 3-ring release system, and the reserve to be deployed. Most skydivers also equip themselves with small barometric computers that will automatically activate the reserve parachute if the skydiver himself has not deployed a parachute to reduce his rate of descent by a preset altitude.

In the United States, the average parachute fatality rate is approximately one fatality in each 80,000 jumps. Most injuries and fatalities in sport skydiving occur under a fully functional main parachute because the skydiver made an error in judgment while flying the canopy, resulting in high-speed impact with the ground, impact with a hazard on the ground that might otherwise have been avoided, or collision with another skydiver under canopy. Types of malfunctions, include the “Mae West”, which is a type of round parachute malfunction which contorts the shape of the canopy into the appearance of a brassiere; “squidding”, which occurs when a parachute fails to inflate properly and its sides are forced inside the canopy; a “cigarette roll”, which occurs when a parachute deploys fully from the bag but fails to open, thus causing the parachute to appear as a vertical column of cloth (in the general shape of a cigarette), providing the jumper with very little drag; and an “inversion”, which occurs when one skirt of the canopy blows between the suspension lines on the opposite side of the parachute and then catches air. That portion then forms a secondary lobe with the canopy inverted. The secondary lobe grows until the canopy turns completely inside out.

Such malfunctions (and other accidents) are likely to occur when a parachute is deployed at too low an altitude, thus not allowing the parachute time to properly open and not providing sufficient drag to slow the user during the fall. Conventional parachutes cannot be used in emergency situations, such as when a user must evacuate an office building, because of this limitation.

FIG. 2 illustrates a typical folding umbrella. Umbrella 100 includes a telescopic tube 118 having opposed upper and lower ends, and having a center ball spring 108 or the like. A typical crook handle 102 is secured to the lower end thereof, with a tip cup 104 or the like being mounted on the upper end of handle 102 and annularly grasping the lower end of tube 118. An annular runner 110 is slidably mounted on telescoping tube 118. In an automatically opening umbrella, runner 110 is elastically biased, and is releasably held in a lowered or collapsed position by a lower spring-biased catch 106, and an upper spring-biased catch 112.

A stretcher, which includes a plurality of radially extending supports, is mounted on the upper end of runner 110 for extending ribs 116 (and the attached canopy 128) as runner 110 slides upwardly with respect to telescoping tube 118. Ribs 116 and canopy 128 extend from a notched end 120 of telescoping tube 118, which may also have cap 122 mounted above the canopy 128, adjacent the upper end 126, for securing the canopy 128 and ribs 116 in place. Additional decorative elements, such as ferule 124, are commonly added.

Referring to FIGS. 3-6, there is shown in greater detail a conventional automatically spreading and collapsing umbrella 200. As shown, umbrella 200 includes an elongate handle 210 with an upper end, a lower end and a middle portion therebetween, along with a ferrule 220, which is fixed on the upper end of the handle 210 for mounting a canopy 260. A tubular runner 230, which is sleeved, is slidably mounted on the middle portion of the handle 210, and a plurality of rib assemblies (for illustrative purposes, only one is shown in FIG. 3), which are disposed at an underside of the canopy 260 to support the canopy 260 in a spread-out position and in a collapsed position. A plurality of stretcher assemblies are further provided (with only one being shown for purposes of clarity) which interconnect the rib assemblies and the runner 230, so as to permit stretching and retracting of the rib assemblies in order to disposed the canopy 260 in a selected one of the spread-out position and the collapsed position when the runner 230 is moved along the handle 210.

Each rib assembly includes a main rib 241, a top rib 242 and an extending rib 243. Each stretcher assembly includes a stretcher 244 which is pivotally connected to the runner 230 and the main rib 241, and a connecting rod 245 which has one end pivotally connected to the stretcher 244 and the other end formed with a sliding slot 251 (best shown in FIG. 6) for sliding engagement with the top rib 242 by means of a pivot pin 221.

For automatically collapsing the rib assembly, a collapsing tension spring 250 and a resilient wire 246 are disposed between the rib assembly and the stretcher assembly. With reference to FIGS. 4 and 5, the resilient wire 246 is formed with a straight wire portion 261 at one end thereof. The straight wire portion 261 passes transversely through the main rib 241 for engagement with one end of the tension spring 250. The other ends of the resilient wire 246 and the tension spring 250 are respectively connected to an engaging hole 252 (as shown in FIG. 6) in the extending rib 243 and the connecting rod 245. As such, stretching of the rib assemblies will extend the tension spring 250 to store an elastic potential energy for restoring the tension spring 250 to facilitate collapsing of the rib assemblies. At the same time, the resilient wire 246 can actuate the extending rib 243 to retract inwardly toward the top rib 242. Such collapsing and expanding umbrellas are well known in the art. Examples of umbrellas and umbrella opening systems are shown in U.S. Pat. Nos. 66,632; 539,762; 6,095,170; and 6,216,712, each of which is herein incorporated by reference in its entirety.

Thus, a mechanically opening parachute solving the aforementioned problems is desired.

### SUMMARY OF THE INVENTION

The mechanically opening parachute is a parachute that may be opened quickly at low altitudes, such as during an emergency exit from an office building. The mechanically opening parachute includes a telescopic tube having opposed upper and lower ends, with the telescopic tube preferably being internally elastically biased. A harness adapted for releasable holding the user is secured to the lower end of the telescopic tube. An annular runner is slidably mounted on the telescopic tube, with the annular runner being elastically biased with respect to the telescopic tube, as is known in conventional, automatically-opening umbrellas.

An elastically-biased catch is mounted on the telescopic tube, with the catch releasably locking the telescopic tube in a collapsed state and releasably holding the annular runner in a lowered state, as is known in conventional, automatically-opening umbrellas. A plurality of ribs are provided, with a first end of each rib being pivotally secured to the upper end of the telescopic tube, and with the plurality of ribs extending radially from the upper end of the telescopic tube, as in a conventional umbrella. A conventional umbrella stretcher is mounted on the annular runner and includes a plurality of supports, with each support extending from the annular runner to a respective one of the plurality of ribs. A parachute canopy is secured to the plurality of ribs.

These and other features of the present invention will become readily apparent upon further review of the following specification and drawings.

### BRIEF DESCRIPTION OF THE DRAWINGS

FIG. 1 is an environmental side view of a mechanically opening parachute according to the present invention, partially broken away to show details thereof.

FIG. 2 is a diagrammatic side view of a conventional prior art umbrella.

FIG. 3 is a schematic view of a portion of a conventional prior art automatic umbrella.

FIG. 4 is a perspective view showing a resilient wire and a collapsing tension spring of the conventional prior art automatic umbrella of FIG. 3.

FIG. 5 is a sectional view of an anchored member of the conventional prior art automatic umbrella shown in FIG. 4, taken along lines 5-5 thereof.

FIG. 6 is a perspective view of the conventional prior art automatic umbrella of FIG. 3 in a stretched state.

Similar reference characters denote corresponding features consistently throughout the attached drawings.

### DETAILED DESCRIPTION OF THE PREFERRED EMBODIMENTS

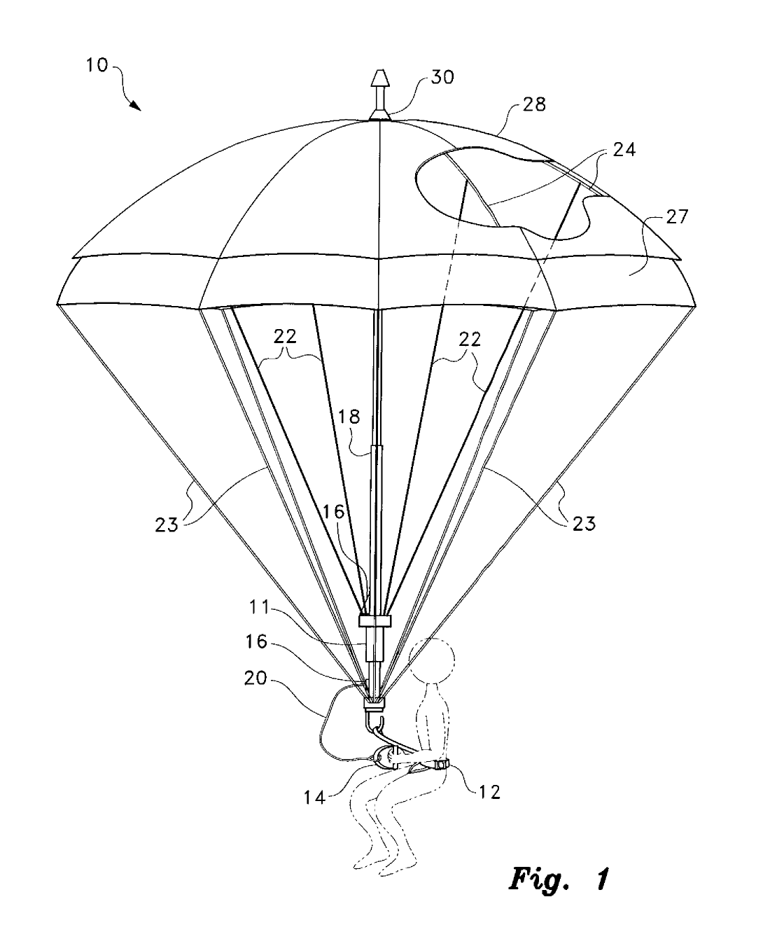

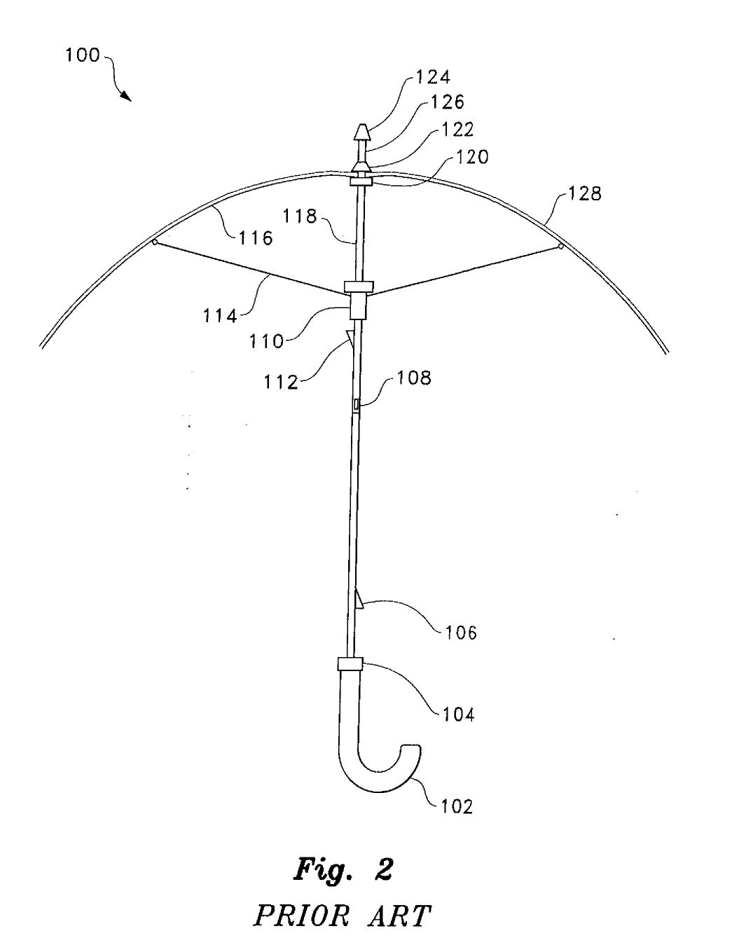

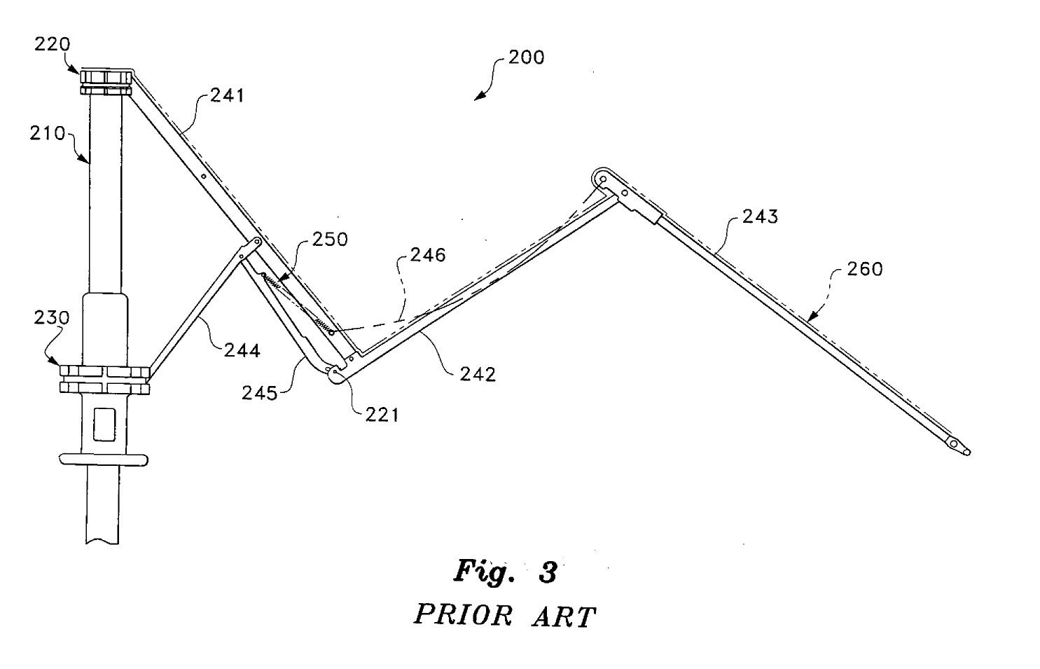

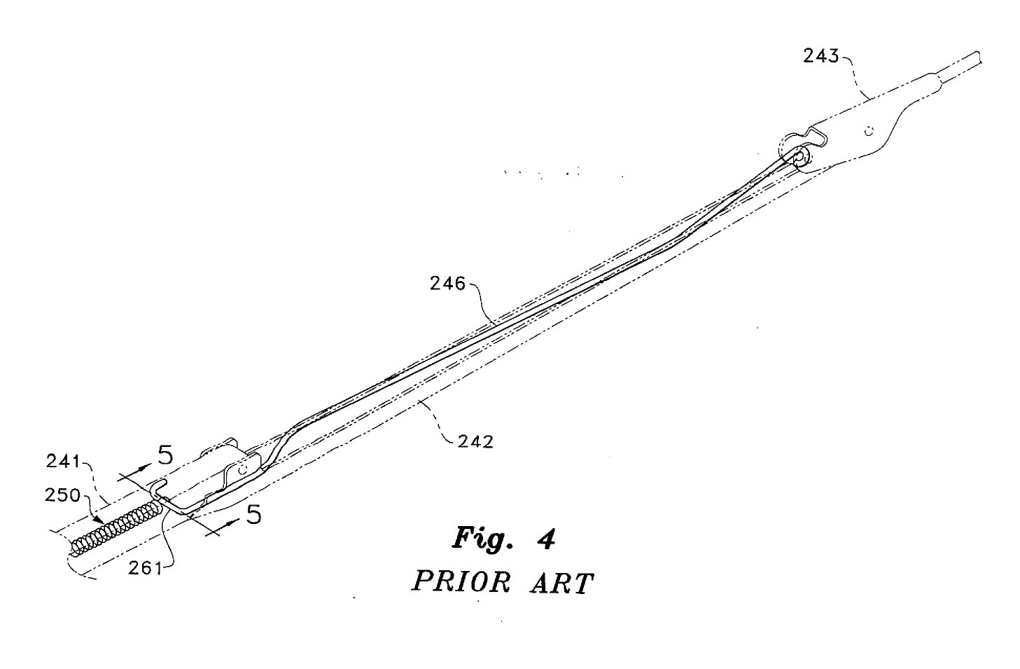

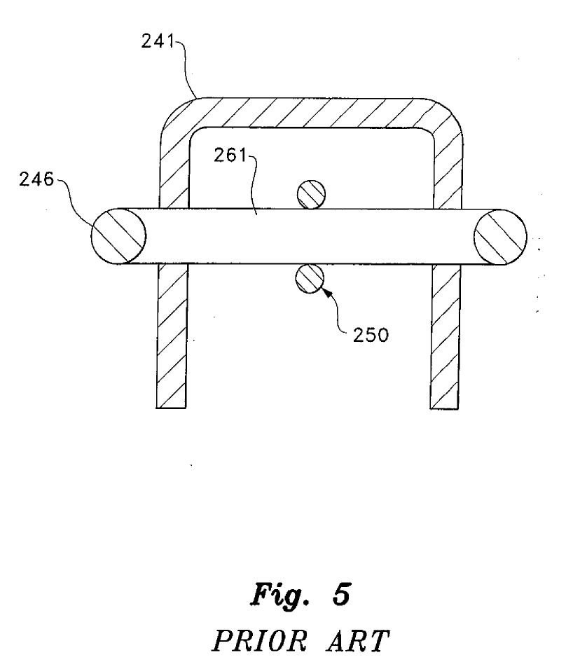

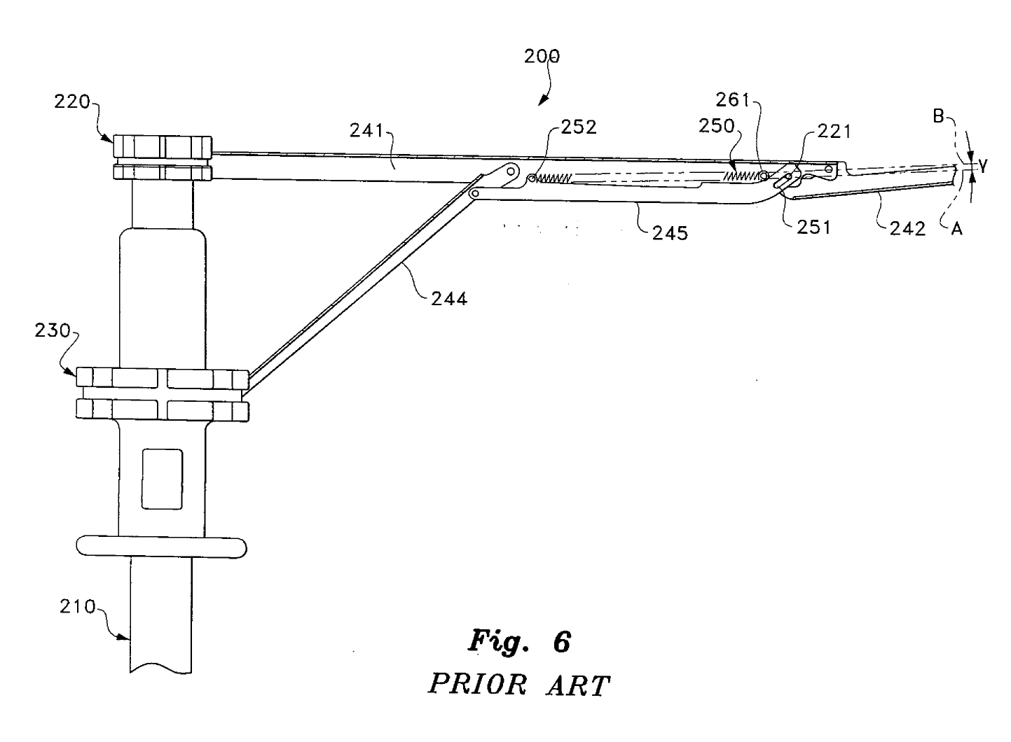

Referring to FIG. 1, the mechanically opening parachute 10 is shown being used in an emergency situation, such as when the user must exit an office building. Parachute 10 is similar in construction to a conventional automatically opening umbrella, such as the prior art umbrella 100 shown in FIG. 2, or the prior art umbrella 200 of FIGS. 3-6. As shown, the mechanically opening emergency parachute 10 includes a telescopic tube 18 having opposed upper and lower ends, and which is preferably spring-biased for automatic expansion thereof, as is shown in the prior art. Replacing the handle 102 of the conventional umbrella 100 is a harness 12, which is fastened about the waist or chest of the user. The harness may be in the form of a buckled belt, as shown, or may be any other suitable type of harness for securely holding the user to the parachute 10. It should be understood that telescopic tube 18 is shown for exemplary purposes only, and that it may include additional tubing, or may be provided so as to be collapsed in a multiple-part state.

The harness 12 is secured to the lower end of telescopic tube 18 by any suitable type of attachment. An annular runner 11 is slidably mounted on telescoping tube 18, as is conventionally known. Runner 11 is preferably elastically biased, and is releasably held in a lowered or collapsed position by a spring-biased catch 16, as in conventional, automatically opening umbrellas. Rather than a release button, catch 16 is released by the user pulling a handle 14, which is connected to the catch 16 by a cord 20. Release of spring-biased catch 16 causes the telescopic tube 18 to expand and causes runner 11 to move upwardly, with respect to telescopic tube 18, as is known in conventional, automatically opening umbrellas.

A stretcher 22, which includes a plurality of radially extending supports, as is well-known, is further provided, with ribs 24 (and the attached canopy 28) extending as runner 11 slides upwardly with respect to telescoping tube 18. Ribs 24 and canopy 28 extend from an upper end of telescoping tube 18, which may be a notched end 30, such as that shown in the conventional umbrella of FIG. 2. As indicated in FIG. 1, the upper ends of the stretchers are fixed to middle or central portions of ribs 24. Preferably, an annular skirt 27 is formed about the lower edge of canopy 28, as shown, in order to maximize stability during usage. It should be understood that the overall contouring of canopy 28 or skirt 27 may be varied, dependent upon the particular desires of the user. As shown, suspension lines 23 secure the edge of skirt 27 to the lower end of tube 18.

It should be understood that any suitable type of opening system, such as those known in the art of umbrellas, may be used to automatically open the canopy 28, which is mounted on the upper end of telescoping tube 18 and actuated by the user pulling handle 14 (when the user is securely held by harness 12), which pulls cord 20 and, in turn, releases spring-biased catch 16 to expand tube 18 and cause expansion of ribs 24.

As an alternative, multiple such parachutes may be secured together, allowing multiple users to exit the building together. For example, a cable may be secured from the upper end of one telescoping tube 18 of one parachute 10 and extend to the lower end of the next telescoping tube 18, or to the harness of the next parachute 10. Parachutes 10 would be daisy-chained together in such a scenario.

It should be understood that any suitable type of opening mechanism may be utilized, and what is shown in FIG. 1 is shown for exemplary purposes only. Further, relative dimensions and overall contouring are ultimately dependent upon desired size and weight considerations, and the particular folding of the canopy is further dependent upon such size and weight considerations. Additionally, the opening mechanism, including the runner, telescopic tube and other conventional elements, may be any suitable opening mechanism, allowing for opening of the canopy in a manner similar to that of a conventional umbrella. For example, expanding, accordion-type ribs may replace ribs 24, as is conventionally known in umbrellas. It should be understood that any suitable type of umbrella-style opening mechanism may be utilized. Such an opening system should allow the overall system to be relatively compact in the closed, or stored, state, and open rapidly to a full, large and expanded state. In the closed state, the parachute 10 may be stored in an elongated storage bag or the like. Following usage of the parachute 10, the canopy 28 may be used for other purposes, such as the formation of an emergency tent or shelter, using any suitable type of support rods or the like.

It is to be understood that the present invention is not limited to the embodiments described above, but encompasses any and all embodiments within the scope of the following claims.

I claim:

1. A mechanically opening parachute, comprising:
a telescopic tube having opposed upper and lower ends;
a harness adapted for releasably holding a user, said harness being secured to the lower end of said telescopic tube;
an annular runner slidably mounted on said telescopic tube;
means for automatically extending said telescopic tube;
means for automatically sliding said annular runner upwardly with respect to said telescopic tube;
a plurality of ribs, each said rib having opposed first and second ends, the first end of each said rib being pivotally secured to the upper end of said telescopic tube, the second end thereof being free, said plurality of ribs extending radially from the upper end of said telescopic tube;
a stretcher mounted on said annular runner and comprising a plurality of supports, each said support extending from said annular runner to a respective one of said plurality of ribs; and
a canopy secured to said plurality of ribs.

2. The mechanically opening parachute as recited in claim 1, wherein said telescopic tube is internally elastically biased.

3. The mechanically opening parachute as recited in claim 2, wherein said annular runner is elastically biased with respect to said telescopic tube.

4. The mechanically opening parachute as recited in claim 3, wherein said means for automatically extending said telescopic tube and said means for automatically sliding said annular running upwardly with respect to said telescopic tube comprise an elastically-biased catch mounted on said telescopic tube, said catch releasably locking said telescopic tube in a collapsed state and releasably holding said annular runner in a lowered state.

5. The mechanically opening parachute as recited in claim 4, wherein said means for automatically extending said telescopic tube and said means for automatically sliding said annular running upwardly with respect to said telescopic tube further comprise a cable having opposed upper and lower ends, the upper end thereof being secured to the elastically-biased catch, the lower end thereof being free and being adapted for grasping by the user to selectively pull and actuate the elastically-biased catch.

6. The mechanically opening parachute as recited in claim 5, further comprising a handle secured to the lower end of the cable.

7. The mechanically opening parachute as recited in claim 1, further comprising a peripheral skirt having opposed upper and lower edges, the upper edge thereof being secured to a peripheral edge of said canopy.

8. The mechanically opening parachute as recited in claim 7, further comprising at least one suspension cord having opposed upper and lower ends, the lower end thereof being secured to the lower end of said telescopic tube, the upper end thereof being secured to the lower edge of said peripheral skirt.

9. A mechanically opening parachute, comprising:
a telescopic tube having opposed upper and lower ends, said telescopic tube being internally elastically biased;
a harness adapted for releasably holding a user, said harness being secured to the lower end of said telescopic tube;
an annular runner slidably mounted on said telescopic tube, said annular runner being elastically-biased with respect to said telescopic tube;
means for automatically extending said telescopic tube;
means for automatically sliding said annular runner upwardly with respect to said to telescopic tube;
a plurality of ribs, each said rib having opposed first and second ends, the first end of each said rib being pivotally secured to the upper end of said telescopic tube, the second end thereof being free, said plurality of ribs extending radially from the upper end of said telescopic tube;
a stretcher mounted on said annular runner and comprising a plurality of supports, each said support extending from said annular runner to a respective one of said plurality of ribs; and
a canopy secured to said plurality of ribs.

10. The mechanically opening parachute as recited in claim 9, wherein said means for automatically extending said telescopic tube and said means for automatically sliding said annular running upwardly with respect to said telescopic tube comprise an elastically-biased catch mounted on said telescopic tube, said catch releasably locking said telescopic tube in a collapsed state and releasably holding said annular runner in a lowered state.

11. The mechanically opening parachute as recited in claim 10, wherein said means for automatically extending said telescopic tube and said means for automatically sliding said annular running upwardly with respect to said telescopic tube further comprise a cable having opposed upper and lower ends, the upper end thereof being secured to the elastically-biased catch, the lower end thereof being free and being adapted for grasping by the user to selectively pull and actuate the elastically-biased catch.

12. The mechanically opening parachute as recited in claim 11, further comprising a handle secured to the lower end of the cable.

13. The mechanically opening parachute as recited in claim 12, further comprising an annular skirt secured to a peripheral edge of said canopy.

14. The mechanically opening parachute as recited in claim 13, further comprising at least one suspension cord having opposed upper and lower ends, the lower end thereof being secured to the lower end of said telescopic tube, the upper end thereof being secured to a lower edge of said annular skirt.
